(19) United States
(12) Patent Application Publication
(10) Pub. No.: US 2021/0345384 A1
(43) Pub. Date: Nov. 4, 2021

(54) Latency Reduction for Network Scheduled Sidelink Resource Allocation

(71) Applicant: Telefonaktiebolaget LM Ericsson (PUBL), Stockholm (SE)

(72) Inventors: Zhang Zhang, BEIJING (CN); Marco Belleschi, SOLNA (SE)

(21) Appl. No.: 17/279,912

(22) PCT Filed: Sep. 25, 2019
(86) PCT No.: PCT/EP2019/075889

§ 371 Date: Mar. 25, 2021

(30) Foreign Application Priority Data
Sep. 27, 2018 (CN) PCT/CN2018/108080

(51) Int. Cl. H04W 72/12; H04W 72/14

(52) U.S. Cl. CPC H04W 72/1284; H04W 72/14

(57) ABSTRACT

A method performed by a wireless device (110) includes determining that the wireless device has data to transmit in the sidelink, SL, buffer. A special scheduling request, SR, is transmitted using a SR resource to the network node to indicate that a SL resource allocation, SL RA, is needed. A grant is received from the network node for transmitting at least the data in the SL buffer. Based on the grant, at least the data in the SL buffer is transmitted.

### BACKGROUND

In Release 14, support for Vehicle-to-anything (V2X) communication was introduced to the LTE specification. V2X is a collective term which includes any combination of direct communication between vehicles, pedestrians and infrastructure. V2X communication may take advantage of a network (NW) infrastructure, when available, but at least basic V2X connectivity should be possible even in case of lack of coverage. Providing an LTE-based V2X interface may be economically advantageous because of the LTE economies of scale and it may enable tighter integration between communications with the NW infrastructure in Vehicle-to-infrastructure (V2I) and Vehicle-to-Pedestrian (V2P) and Vehicle-to-vehicle (V2V) communications, as compared to using a dedicated V2X technology.

FIG. 1 illustrates V2X scenarios for an LTE-based network. V2X communications may carry both non-safety and safety information, where each of the applications and services may be associated with specific requirements sets such as, for example, in terms of latency, reliability, capacity, etc. ETSI has defined two types of messages for road safety: Co-operative

Awareness Message (CAM) and Decentralized Environmental Notification Message (DENM).

The CAM message is intended to enable vehicles, including emergency vehicles, to notify their presence and other relevant parameters in a broadcast fashion. Such messages target other vehicles, pedestrians, and infrastructure, and are handled by their applications. CAM message also serves as active assistance to safety driving for normal traffic. The availability of a CAM message is indicatively checked for every 100 ms, yielding a maximum detection latency requirement of <=100 ms for most messages. However, the latency requirement for Pre-crash sensing warning is 50 ms.

The DENM message is event-triggered, such as by braking, and the availability of a DENM message is also checked for every 100 ms, and the requirement of maximum latency is <=100 ms.

The package size of CAM and DENM message varies from 100+ to 800+ bytes and the typical size is around 300 bytes. The message is supposed to be detected by all vehicles in proximity.

The Society of the Automotive Engineers (SAE) also defined the Basic Safety Message (BSM) for Distributed Short Range Communications (DSRC) with various messages sizes defined.

According to the importance and urgency of the messages, the BSMs are further classified into different priorities.

There are two different resource allocation (RA) procedures for V2X on sidelink, i.e. centralized RA (so called “mode 3”) and distributed RA (so called “mode 4”). The transmission resources are selected within a resource pool which is predefined or configured by the NW.

Sidelink is a special kind of communication mechanism between device and device (D2D) or UE and UE without passing the payload data through a base station of a cellular communication network (e.g. eNB or gNB).

For Mode 4, there are two fundamental features for achieving a well-functioning distributed operation: semi-persistent transmission and sensing-based resource allocation. Semi-persistent transmission is based on the fact that the user equipment (UE) can predict with reasonable accuracy the arrival of new packets to the transmission buffer. This is so because LTE V2X was mainly designed to support periodic transmissions such as CAM. Using appropriate signaling, a first UE performing transmissions can notify all other UEs about its intention to transmit on specific radio resources at a certain time in the future. Using a sensing algorithm, a second UE can learn the presence of these semi-persistent transmissions. This information can be used by the second UE when selecting radio resources. In this way, collisions between UEs can be avoided.

In Mode 3, the UEs are tightly controlled by the NW. Typical transmissions by a Mode 3 UE are performed as follows:
1. The UE requests resources for sidelink (SL) transmissions to the NW by sending sidelink buffer status report (SL BSR) in uplink (UL). Transmitting SL BSR requires an UL grant. The UL grant may be received either dynamically on Physical Downlink Control Channel (PDCCH) when UE is in connected mode, or in a random access response (RAR) during random access. If a connected UE does not have a uplink (UL) grant yet, the UE needs to first send a scheduling request (SR) to the gNodeB (gNB), and then the gNB allocates a UL grant to the UE.
2. The NW grants resources for SL transmission to the UE.
3. The UE performs the SL transmission on the resources granted by the NW.

The grant provided by the NW may be valid for the transmission of a single transport block (TB), including its retransmission; or for the transmission of multiple TBs if it is a semi-persistent scheduling (SPS) grant.

3GPP SA1 working group has completed new service requirements for future V2X services in the FS_eV2X. SA1 have identified twenty-five use cases for advanced

V2X services which will be used in 5G (i.e. LTE and NR). Such use cases are categorized into four use case groups: vehicles platooning, extended sensors, advanced driving and remote driving. The consolidated requirements for each use case group are captured in TR 22.886, Version 16.1.1. For these advanced applications, the expected requirements to meet the needed data rate, capacity, reliability, latency, communication range and speed are made more stringent.

The Logical Channel Prioritization procedure is applied when a new transmission is performed. For the Logical Channel Prioritization procedure, the MAC entity shall take into account the following relative priority in decreasing order:
MAC control element for C-RNTI or data from UL-CCCH;
MAC control element for DPR;
MAC control element for SPS confirmation;
MAC control element for BSR, with exception of BSR included for padding;
MAC control element for PHR, Extended PHR, or Dual Connectivity PHR;
MAC control element for Sidelink BSR, with exception of Sidelink BSR included for padding;
data from any Logical Channel, except data from UL-CCCH;
MAC control element for Recommended bit rate query;
MAC control element for BSR included for padding;
MAC control element for SL BSR included for padding.

Certain problems exist. For example, the latency in the current NW scheduled RA may increase due to different reasons. First, if the UL grant is not sufficient for transmitting the SL BSR, an UL BSR has to be sent first to request the gNB to issue a larger UL grant for transmitting the SL BSR. This will increase the network scheduled resource allocation (RA). Second, SL BSR has lower priority than several other MAC CEs for UL, this may also increase the latency of NW scheduled RA. An increased latency is undesired especially for delay critical eV2X services and should be mitigated.

### SUMMARY

Certain aspects of the present disclosure and their embodiments may provide solutions to these or other challenges. For example, according to certain embodiments, a method is provided for reducing latency in network scheduled side link resource allocation (SL RA) (i.e. mode 3 in LTE or mode 1 in NR).

According to certain embodiments, a method performed by a wireless device includes determining that the wireless device has data to transmit in at least a sidelink SL) buffer. Using a scheduling request (SR) resource, a special scheduling request is transmitted to a network node to indicate that a SL resource allocation (SL RA) is needed. A grant for transmitting at least the data in the SL buffer is received from a network node. Based on the grant, at least the data in the SL buffer is transmitted.

According to certain embodiments, a method performed by a base station includes receiving, from a wireless device, a special scheduling request associated with a SR resource. Based on the SR resource, it is determined that the wireless device has data to transmit on either a SL or the SL and an UL. A grant sufficient for transmitting the data on the SL or the SL and the UL is transmitted to the wireless device.

According to certain embodiments, a method performed by a wireless device includes determining that the wireless device has data to transmit in the SL buffer. A special random access channel (RACH) procedure is initiated for transitioning into a connected mode or for requesting an on-demand V2X configuration. A grant for transmitting at least the data in the SL buffer is received from a network node. Based on the grant, at least the data in the SL buffer is transmitted.

According to certain embodiments, a method performed by a base station includes receiving, from a wireless device, an indication that the wireless device has initiated a special RACH procedure for transitioning into a connected mode or for requesting an on-demand V2X configuration. Based on the indication, it is determined that the wireless device had data to transmit on either a SL or the SL and an UL. A grant sufficient for transmitting the data on the SL or the SL and the UL is transmitted to the wireless device. Based on the grant, the data on the SL or the SL and the UL is received.

According to certain embodiments, a wireless device includes processing circuitry configured to determine that the wireless device has data to transmit in at least a SL buffer. Using a scheduling request (SR) resource, the processing circuitry transmits a special scheduling request to a network node to indicate that a SL resource allocation (SL RA) is needed. The processing circuitry is configured to receive a grant for transmitting at least the data in the SL buffer from a network node. Based on the grant, the processing circuitry is configured to transmit at least the data in the SL buffer.

According to certain embodiments, a base station includes processing circuitry configured to receive, from a wireless device, a special scheduling request associated with a SR resource. Based on the SR resource, the processing circuitry is configured to determine that the wireless device has data to transmit on either a SL or the SL and an UL. A grant sufficient for transmitting the data on the SL or the SL and the UL is transmitted to the wireless device.

According to certain embodiments, a wireless device includes processing circuitry configured to determine that the wireless device has data to transmit in the SL buffer. The processing circuitry is configured to initiate a special RACH procedure for transitioning into a connected mode or for requesting an on-demand V2X configuration. The processing circuitry receives a grant for transmitting at least the data in the SL buffer from a network node. Based on the grant, the processing circuitry is configured to transmit at least the data in the SL buffer.

According to certain embodiments, a base station includes processing circuitry configured to receive, from a wireless device, an indication that the wireless device has initiated a special RACH procedure for transitioning into a connected mode or for requesting an on-demand V2X configuration. Based on the indication, the processing circuitry is configured to determine that the wireless device had data to transmit on either a SL or the SL and an UL. The processing circuitry is configured to transmit a grant sufficient for transmitting the data on the SL or the SL and the UL to the wireless device. Based on the grant, the processing circuitry is configured to receive the data on the SL or the SL and the UL.

Certain embodiments may provide one or more of the following technical advantages. For example, one technical advantage may be that certain embodiments may be that latency may be reduced in NW scheduled SL RA. Accordingly, certain embodiments may provide improved performance for eV2X services.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates V2X scenarios for an LTE-based network;

FIG. 2 illustrates an example wireless network, according to certain embodiments;

FIG. 3 illustrates an example network node, according to certain embodiments;

FIG. 4 illustrates an example wireless device, according to certain embodiments;

FIG. 5 illustrate an example user equipment, according to certain embodiments;

FIG. 6 illustrates a virtualization environment in which functions implemented by some embodiments may be virtualized, according to certain embodiments;

FIG. 7 illustrates a telecommunication network connected via an intermediate network to a host computer, according to certain embodiments;

FIG. 8 illustrates a generalized block diagram of a host computer communicating via a base station with a user equipment over a partially wireless connection, according to certain embodiments;

FIG. 9 illustrates a method implemented in a communication system, according to one embodiment;

FIG. 10 illustrates another method implemented in a communication system, according to one embodiment;

FIG. 11 illustrates another method implemented in a communication system, according to one embodiment;

FIG. 12 illustrates another method implemented in a communication system, according to one embodiment;

FIG. 13 illustrates an example method by a wireless device, according to certain embodiments;

FIG. 14 illustrates an exemplary virtual computing device, according to certain embodiments;

FIG. 15 illustrates another example method by a wireless device, according to certain embodiments;

FIG. 16 illustrates another exemplary virtual computing device, according to certain embodiments;

FIG. 17 illustrates yet another example method by a wireless device, according to certain embodiments;

FIG. 18 illustrates another exemplary virtual computing device, according to certain embodiments;

FIG. 19 illustrates an example method by a network node, according to certain embodiments;

FIG. 20 illustrates another exemplary virtual computing device, according to certain embodiments;

FIG. 21 illustrates another method by a network node, according to certain embodiments;

FIG. 22 illustrates another exemplary virtual computing device, according to certain embodiments;

FIG. 23 illustrates yet another method by a network node, according to certain embodiments;

FIG. 24 illustrates another exemplary virtual computing device, according to certain embodiments;

FIG. 25 illustrates still another method by a network node, according to certain embodiments; and

FIG. 26 illustrates another exemplary virtual computing device, according to certain embodiments.

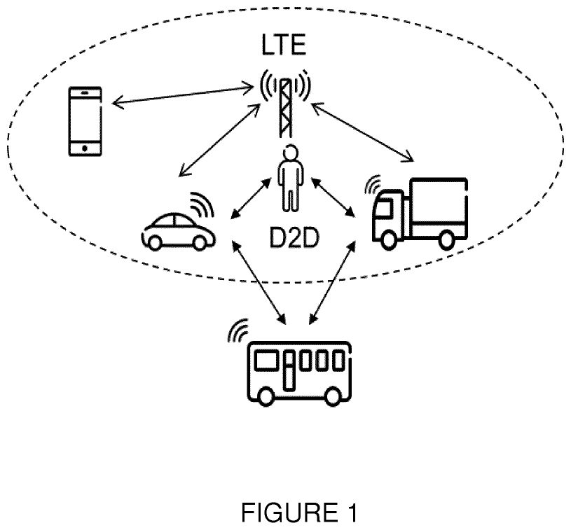

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a user equipment (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category Ml, UE category M2, ProSe UE, V2V UE, V2X UE, etc. Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

In the following embodiments, with priority is intended to include any priority tag which characterizes a certain packet or QoS flow, such as QCI, 5QI, PPPP, LCID, LCG etc.

According to certain embodiments, latency in network scheduled SL RA (i.e. mode 3 in LTE or mode 1 in NR) may be reduced via one or more of the following methods:
Introducing a special scheduling request (SR) (configuration), which may also be called a sidelink SR (SL SR) so that the network knows that a SL grant will be transmitted and provides large enough uplink (UL) grant to the UE. The UE uses the special SR when it has data available for transmission in the SL buffer.
Introducing a special random access channel (RACH) configuration and/or procedure so that the network knows that the UE enters connected mode to perform network scheduled SL RA and provides large enough initial UL grant to the UE. The UE uses the special RACH procedure when it has data available for transmission in the SL buffer and the UE either needs to get into CONNECTED mode or it needs to request on demand V2X configuration, e.g. to request the network to provide the system information block (SIB) signaling containing SL V2X related configuration (such as SL time/frequency resources and transmitting parameters, etc.). It can also be used for PRACH SL SR, e.g. when the UE has reached the maximum amount of SL SR attempts.
Prioritizing SL buffer status report (BSR) over other MAC CE if the SL services require low latency.

Regarding the proposed special SL SR configuration and/or procedure, the following options may be considered:
Single Dedicated SL SR resource on physical uplink control channel (PUCCH).
Multiple Dedicated SL SR resources on PUCCH, where each SL SR resource corresponds to one or more SL logical channels.
Scrambling PUCCH carrying SR by SL radio network temporary identifier (RNTI).
Multi-bit SR with one or more bit in the bitmap used for SL. In case more than one bit is used for SL, each of such bit may be mapped to one or more SL logical channels

When the network node receives the special SR, the network node can know that the UE wants to transmit on the SL or both SL and UL, and the network node may provide an UL grant such that the SL BSR or both the SL BSR and the Uu BSR can fit in. By this it could be avoided that a UL BSR has to be sent first to request the network node to issue a larger UL grant for transmitting the SL BSR thus a reduced latency.

According to certain embodiments, the UE may be configured with both:
one or more SL SR resources (according to the first two of the above possible options) to be used by the UE when there are data available for transmission on the SL buffer; and
one or more legacy Uu SR to be used by the UE when there is data available for transmission on the Uu buffer.

A Uu buffer is a buffer for data which is transmitted or will be transmitted on the radio interface between the UE and the radio access network which may comprises a base station, like a NodeB, eNB or gNB. Uu

In such a scenario, different methods may be possible:
If the UE has in the buffer both SL data and Uu data, the UE uses the SL SR resource or the Uu SR resource whichever comes first in time to transmit the SL SR (e.g. scrambling the PUCCH with SL RNTI) .
If the UE has in the buffer both SL data and Uu data, the UE uses the SL SR resource or the Uu SR resource whichever comes first in time to transmit the SL SR only if either the SL data or the Uu data in the respective SL/Uu buffer have priority higher than a certain threshold. For instance, for SL transmission, the UE is allowed to use the Uu SR resource to transmit the SL SR only if SL data in the SL buffer has priority higher than a certain threshold or if the priority of the highest priority SL data is higher than the priority of the highest priority Uu data Vice versa for Uu transmissions.
If the UE has only SL data in the buffer, it can just use the SL SR resource to transmit the SL SR, or use the Uu SR resource to transmit the SL SR optionally only if the priority of the highest priority SL data in the SL buffer have priority higher than a certain threshold. The UE could use either the SL SR resource or the Uu SR resource, whichever comes first in time.

According to certain embodiments wherein a special RACH (configuration) is provided, the following options may be considered:
Special RACH preamble formats and/or resources.
An explicit indication in message 3 of the RACH procedure. Message 3 may be a RRC Connection Request message which is send by the UE to the network once the UE decoding the contents of the Random Access Response (RAR). In the following the term “Message 3” is used to indicate any kind of connection request in a RACH procedure.

With this the network node can know that the UE has data to be transmitted on SL, or both SL and UL. and the network node may provide a large enough (initial) UL grant such that the SL BSR or both the SL BSR and the Uu BSR can fit.in. This also avoids the need of sending an extra UL BSR for transmitting the SL BSR thus a reduced latency.

According to various particular embodiments, the message 3 may contain one or more of:
A field indicating whether the random access was performed because of SL data being available. In one method the field is set if there is at least a MAC SDU buffered in the SL buffer. In another method, if the UE has both UL data and SL data in the respective Uu/SL buffer, the UE could set the field in the message 3. In another method, the field is set only if the priority of the SL data is above a certain threshold, or if the priority of the SL data is higher than the priority of the Uu data.
The carrier(s) that are mapped by higher layers to the SL data having priority higher than certain threshold or higher than the priority of the highest priority Uu data. Upon receiving such information the gNB may provide a SL grant valid in the indicated carriers.
The priority (e.g. QoS requirements, QCI, 5QI, PPPP, LCID, etc) of SL data, optionally only for SL data having priority higher than certain threshold or higher than the priority of the highest priority Uu data
The V2X service identifier (e.g. link layer destination address, PSID, AID) of the SL data having priority higher than certain threshold or higher than the priority of the highest priority Uu data

According to certain other embodiments, SL BSR prioritization may be performed by the UE based on some prioritization criteria. The prioritization criteria may be preconfigured in the UE or configured by the network node and sent to the UE via dedicated or common RRC signaling.

According to certain embodiments, any one or combination of the following criteria can be used to determine whether SL BSR is prioritized or not:
Prioritize SL BSR if the packet of the SL service has a priority higher than a (pre)defined threshold.
Prioritize SL BSR if the priority of the highest priority SL data is higher than a certain threshold.
Prioritize SL BSR if the priority of the highest priority SL data has higher priority than the priority of the highest priority Uu data
Prioritize SL BSR if the priority of the highest priority Uu data is lower than a certain threshold
Prioritize SL BSR if the previously transmitted SR was transmitted on SL SR resources.

According to certain embodiments, this prioritization may also be applied to SR. For example, the UE may generate and transmit SL SR indicating SL transmission if the SL transmission should be prioritized according to the criteria mentioned above. For instance, in case the SL SR (resource) and the Uu SR (resource) occur at the same time, the UE selects to transmit either the SL SR or the Uu SR depending on the priority of the SL and Uu. In a particular embodiment, for example, the UE may select to transmit the SL SR if the priority of the highest priority SL data is higher than a certain threshold or the priority of the highest priority Uu data. If the SL and Uu priority is the same, the UE may select the Uu SR by default, or it randomly selects either the SL SR or the Uu SR with equal probability.

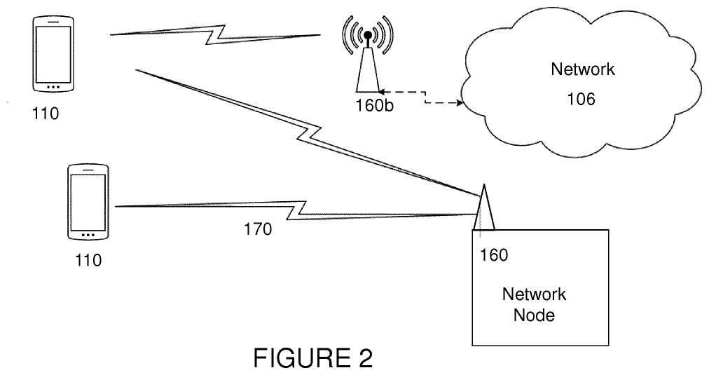

FIG. 2 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 2. For simplicity, the wireless network of FIG. 2 only depicts network 106, network nodes 160 and 160b, and wireless devices 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

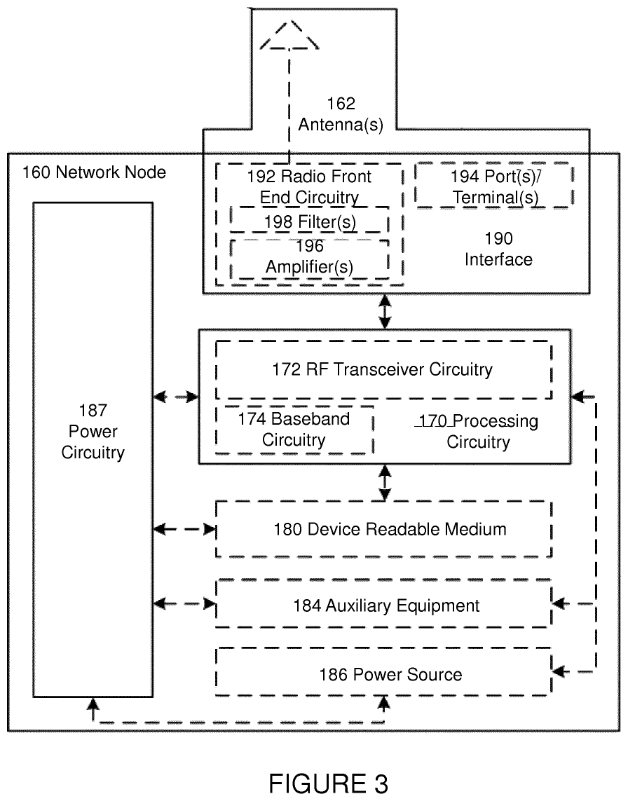

FIG. 3 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 3, network node 160 includes processing circuitry 170, device readable medium 180, interface 190, auxiliary equipment 184, power source 186, power circuitry 187, and antenna 162. Although network node 160 illustrated in the example wireless network of FIG. 2 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 3 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

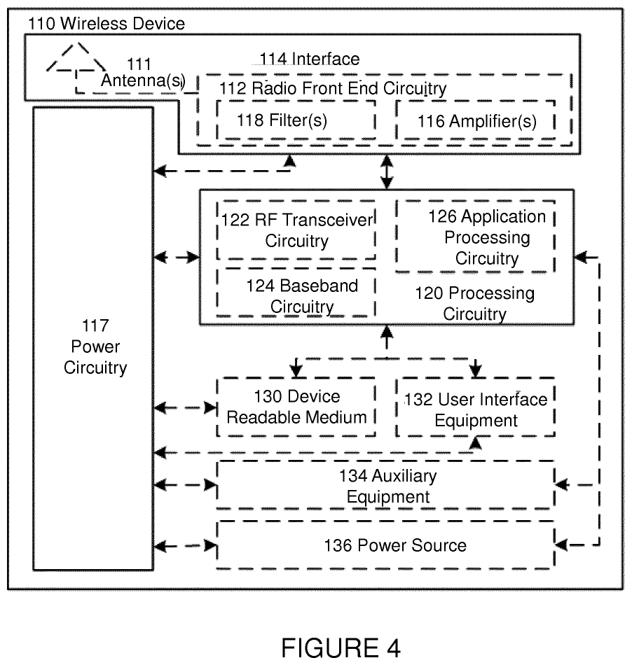

FIG. 4 illustrates an example wireless device 110, according to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. W

Wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

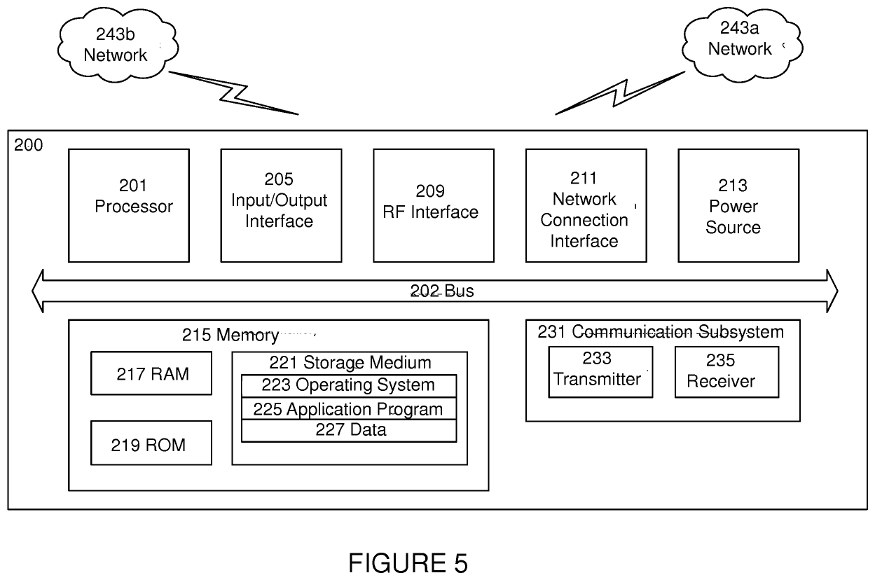

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 5 is a UE, the components discussed herein are equally applicable to a wireless device, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof Storage medium 221 includes operating system 223, application program 225, and data 227. In other embodiments, storage medium 221 may include other similar types of information. Certain UEs may utilize all of the components shown in FIG. 3, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

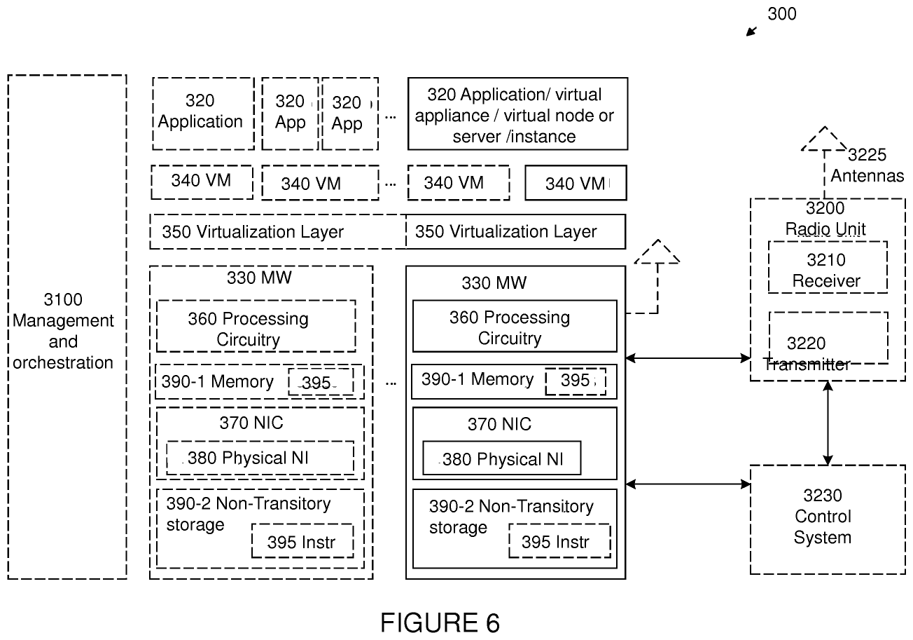

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non- virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 6.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

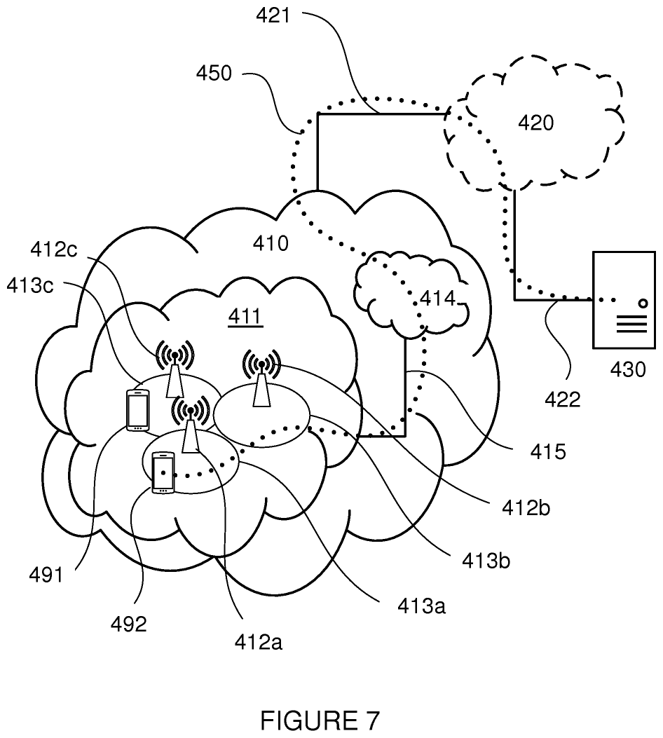

FIG. 7 illustrates a telecommunication network connected via an intermediate network to a host computer in accordance with some embodiments.

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wc. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

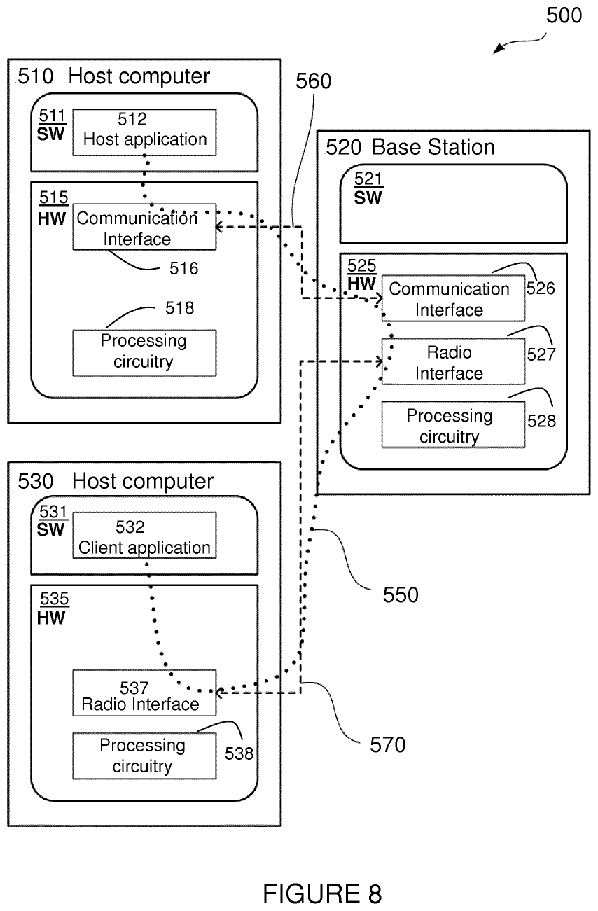

FIG. 8 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 7, respectively. This is to say, the inner workings of these entities may be as shown in FIG. 8 and independently, the surrounding network topology may be that of FIG. 7.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

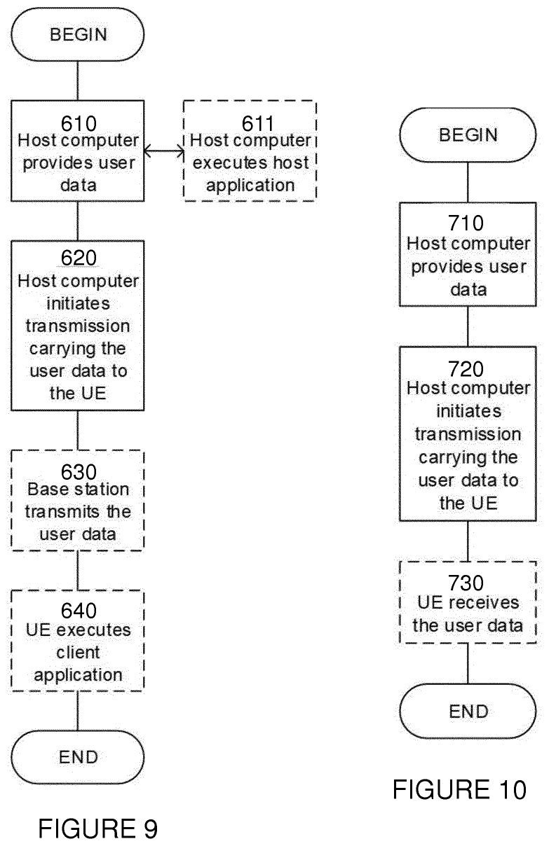

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

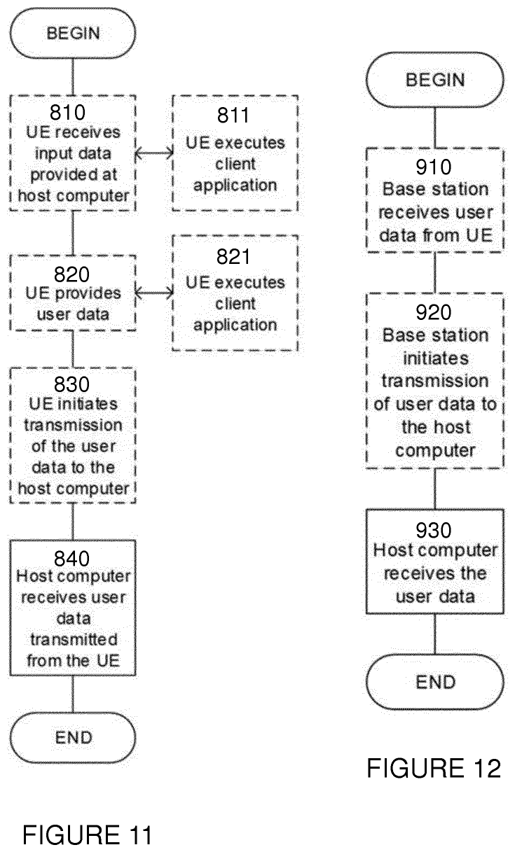

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

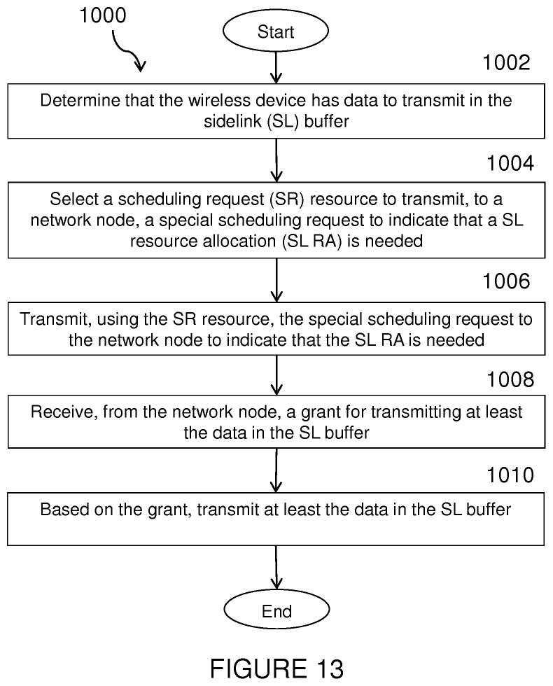

FIG. 13 depicts a method 1000 by a wireless device, according to certain embodiments. At step 1002, the wireless device determines that the wireless device has data to transmit in the SL buffer. At step 1004, the wireless device selects a SR resource to transmit, to a network node, a special scheduling request to indicate that a SL RA is needed. At step 1006, the wireless device transmits, using the SR resource, the special scheduling request to the network node to indicate that the SL RA is needed. The wireless device receives, from the network node, a grant for transmitting at least the data in the SL buffer, at step 1008. At step 1010, based on the grant, the wireless device transmits at least the data in the SL buffer.

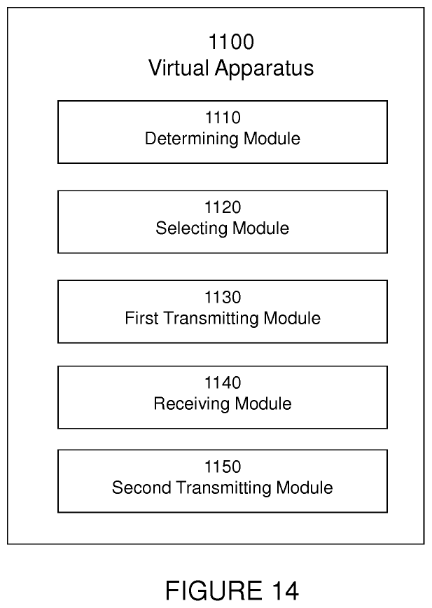

FIG. 14 illustrates a schematic block diagram of a virtual apparatus 1100 in a wireless network (for example, the wireless network shown in FIG. 2). The apparatus may be implemented in a wireless device or network node (e.g., wireless device 110 or network node 160 shown in FIG. 2). Apparatus 1100 is operable to carry out the example method described with reference to FIG. 13 and possibly any other processes or methods disclosed herein. It is also to be understood that the method of FIG. 13 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1110, selecting module 1120, first transmitting module 1130, receiving module 1140, second transmitting module 1150, and any other suitable units of apparatus 1100 to perform corresponding functions according one or more embodiments of the present disclosure.

According to certain embodiments, determining module 1110 may perform certain of the determining functions of the apparatus 1100. For example, determining module 1110 may determine that the wireless device has data to transmit in the SL buffer.

According to certain embodiments, selecting module 1120 may perform certain of the selecting functions of the apparatus 1100. For example, selecting module 1120 may select a SR resource to transmit, to a network node, a special scheduling request to indicate that a SL RA is needed.

According to certain embodiments, first transmitting module 1130 may perform certain of the transmitting functions of the apparatus 1100. For example, first transmitting module 1130 may transmit, using the SR resource, the special scheduling request to the network node to indicate that the SL RA is needed.

According to certain embodiments, receiving module 1140 may perform certain of the receiving functions of the apparatus 1100. For example, receiving module 1140 may receive, from the network node, a grant for transmitting at least the data in the SL buffer.

According to certain embodiments, second transmitting module K50 may perform certain of the transmitting functions of the apparatus K00. For example, second transmitting module K50 may transmit at least the data in the SL buffer.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

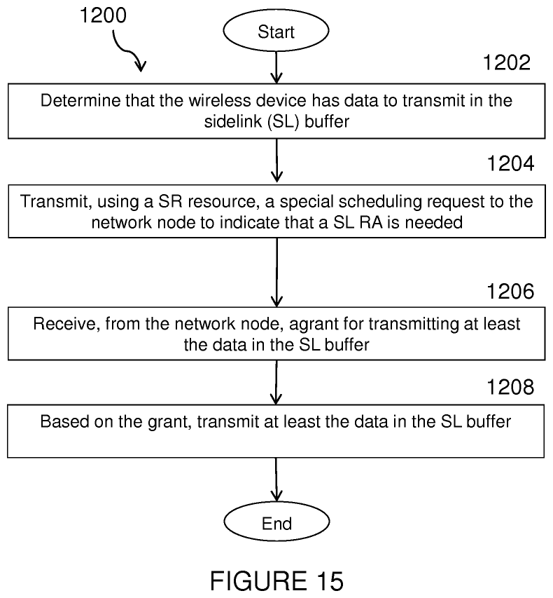

FIG. 15 depicts a method 1200 by a wireless device 110, according to certain embodiments. At step 1202, the wireless device 110 determines that the wireless device 110 has data to transmit in the SL buffer. At step 1004, the wireless device 110 transmits, using a SR resource, a special scheduling request to a network node to indicate that the SL RA is needed. The wireless device 110 receives, from the network node 160, a grant for transmitting at least the data in the SL buffer, at step 1206. At step 1208, based on the grant, the wireless device 110 transmits at least the data in the SL buffer.

In a particular embodiment, the SR resource comprises at least one dedicated SL resource. In a further particular embodiment, the at least one dedicated SL SR resource includes a single dedicated SL SR resource on a physical uplink control channel (PUCCH). In another particular embodiment, the at least one dedicated SL SR resource includes a plurality of dedicated SL SR resources corresponding to one or more SL logical channels on the PUCCH.

According to certain embodiments, each of the plurality of dedicated SL SR resources corresponds to one or more SL logical channels.

According to certain embodiments, using the at least one dedicated SL SR resource to transmit the special SR comprises scrambling a physical uplink control channel carrying the special SR by SL RNTI.

According to certain embodiments, the at least one dedicated SL SR resource comprises one or more bits in a bitmap of a multi-bit SR used for the SL, wherein each of the one or more bits is mapped to an associated one of one or more SL logical channels.

In a particular embodiment, the method further includes determining that the wireless device 110 has data in a Uu buffer to transmit, and the special scheduling request indicates that the wireless device 110 also has data in the Uu buffer to transmit.

In a particular embodiment, selecting the SR resource comprises selecting an earlier of a SL SR resource and a Uu SR resource. In a further particular embodiment, the earlier of the SL SR resource and the Uu SR resource are selected in response to determining that the data in the SL buffer or the Uu buffer has a priority greater than a threshold. In a further particular embodiment, the Uu SR resource is selected for SL SR transmission in response to determining that the data in the SL buffer has a priority greater than a threshold. In a further particular embodiment, the Uu SR resource is selected in response to determining that the data in the SL buffer has a priority that is greater than a priority of the data in the Uu buffer.

In a particular embodiment, the SR resource comprises a Uu SR resource and the Uu SR resource is configured with a priority of the highest priority data in the SL buffer is greater than a threshold.

In a particular embodiment, the method further includes determining that the data in the SL buffer is associated with a SL service requiring low latency and, in response to determining that the data in the SL buffer is associated with a SL service requiring low latency and based on prioritization criteria, prioritizing a SL buffer status report over at least one MAC control element.

In a particular embodiment, prioritizing the SL buffer status report comprises transmitting the buffer status report to a network node before the at least one MAC control element.

In a particular embodiment, the prioritization criteria is received via dedicated RRC signaling or common RRC signaling.

In a particular embodiment, the prioritization criteria indicates that SL buffer status report is prioritized in response to at least one of the following: a packet of the data in the SL buffer has a priority higher than a threshold, a highest priority packet of the data in the SL buffer has a priority higher than a threshold, a highest priority packet in the SL buffer has a higher priority than a priority of a highest priority packet of data in a Uu buffer, and a highest priority packet in a Uu buffer is lower than a threshold.

In a particular embodiment, the method further includes transmitting a SL SR to a network node, the SL SR indicating that the data in the SL buffer is prioritized based on the prioritization criteria.

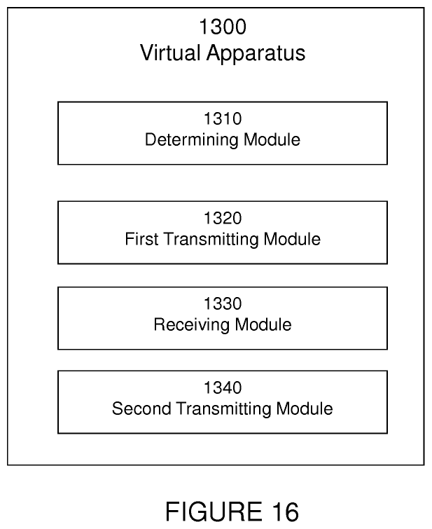

FIG. 16 illustrates a schematic block diagram of a virtual apparatus 1300 in a wireless network (for example, the wireless network shown in FIG. 2). The apparatus may be implemented in a wireless device or network node (e.g., wireless device 110 or network node 160 shown in FIG. 2). Apparatus 1300 is operable to carry out the example method described with reference to FIG. 15 and possibly any other processes or methods disclosed herein. It is also to be understood that the method of FIG. 15 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1310, first transmitting module 1320, receiving module 1330, second transmitting module 1340, and any other suitable units of apparatus 1300 to perform corresponding functions according one or more embodiments of the present disclosure.

According to certain embodiments, determining module 1310 may perform certain of the determining functions of the apparatus 1300. For example, determining module 1310 may determine that the wireless device has data to transmit in the SL buffer.

According to certain embodiments, first transmitting module 1320 may perform certain of the transmitting functions of the apparatus 1300. For example, first transmitting module 1320 may transmit, using the SR resource, the special scheduling request to the network node to indicate that the SL RA is needed.

According to certain embodiments, receiving module 1330 may perform certain of the receiving functions of the apparatus 1300. For example, receiving module 1330 may receive, from the network node, a grant for transmitting at least the data in the SL buffer.

According to certain embodiments, second transmitting module 1340 may perform certain of the transmitting functions of the apparatus 1300. For example, second transmitting module 1340 may transmit at least the data in the SL buffer.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

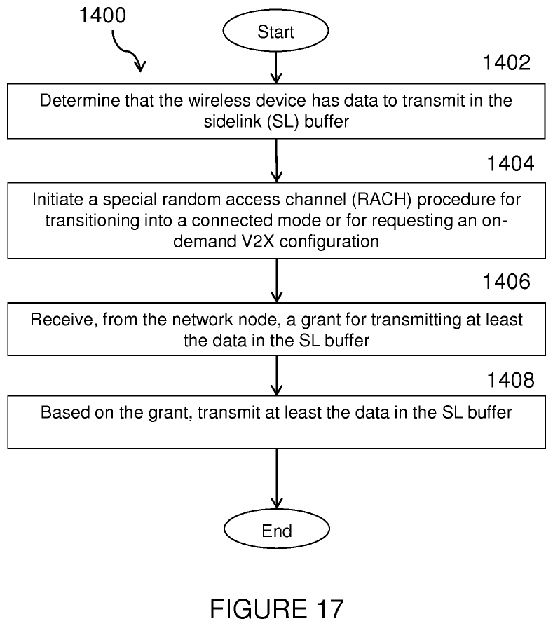

FIG. 17 depicts another method 1400 by a wireless device 110, according to certain embodiments. At step 1402, the wireless device 110 determines that the wireless device 110 has data to transmit in the SL buffer. At step 1404, the wireless device 110 initiates a special RACH procedure for transitioning into a connected mode or for requesting an on-demand V2X configuration. At step 1406, the wireless device 110 receives, from the network node 160, a grant for transmitting at least the data in the SL buffer. Based on the grant, the wireless device 110 transmits at least the data in the SL buffer at step 1208.

In a particular embodiment, requesting the on-demand V2X configuration comprises requesting a SL resource and receiving the grant comprises receiving the SL resource.

In a particular embodiment, the an on-demand V2X configuration comprises transmitting, to a network node, a request for system information block (SIB) signaling comprising a SL V2X related configuration.

In a particular embodiment, the SL V2X related configuration comprises at least one of a SL time resource and a SL frequency resource.

In a particular embodiment, the SL V2X related configuration comprises transmission parameters.

In a particular embodiment, the special RACH procedure is used for PRACH SL scheduling request (SR) when the wireless device has reached a maximum amount of SL SR attempts.

In a particular embodiment, the special RACH procedure comprises a special RACH preamble format and/or resource.

In a particular embodiment, initiating the special RACH procedure comprises transmitting an indication in a message 3, the message 3 comprises a field indicating to a network node that: the wireless device data has data to transmit in the SL buffer, or the wireless device has data to transmit in the SL buffer and data to transmit in an Uu buffer.

In a particular embodiment, the message 3 comprises a field indicating to the network node that the wireless device has data to transmit in the SL buffer and data to transmit in a Uu buffer. In a further particular embodiment, the data to transmit in the SL buffer has a priority greater than a threshold. In a further particular embodiment, the data to transmit in the SL buffer has a priority that is greater than a priority of the data to transmit in the Uu buffer.

In a particular embodiment, the message 3 indicates a plurality of carriers mapped to data in the SL buffer that has a priority greater than a threshold.

In a particular embodiment, the message 3 indicates a plurality of carriers mapped to data in the SL buffer that has a higher priority than data in a Uu buffer.

In a particular embodiment selecting the SR resource comprises selecting an earlier of a SL SR resource and a Uu SR resource.

In a particular embodiment, the message 3 indicates a priority of the data in the SL buffer.

In a particular embodiment, the message 3 comprises a V2X service identifier of data in the SL buffer having a priority higher than a threshold or higher than a priority of data in a Uu buffer.

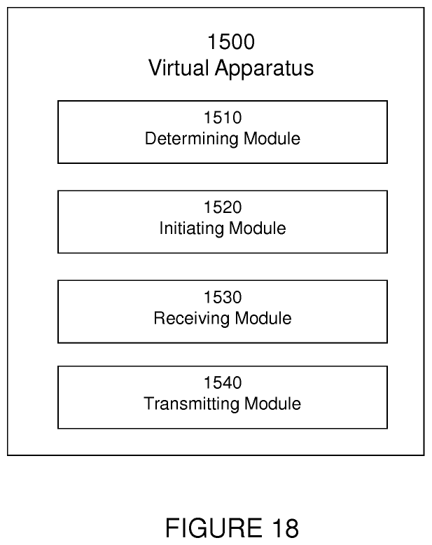

FIG. 18 illustrates a schematic block diagram of a virtual apparatus 1500 in a wireless network (for example, the wireless network shown in FIG. 2). The apparatus may be implemented in a wireless device or network node (e.g., wireless device 110 or network node 160 shown in FIG. 2). Apparatus 1500 is operable to carry out the example method described with reference to FIG. 17 and possibly any other processes or methods disclosed herein. It is also to be understood that the method of FIG. 17 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1510, initiating module 1520, receiving module 1530, transmitting module 1540, and any other suitable units of apparatus 1500 to perform corresponding functions according one or more embodiments of the present disclosure.

According to certain embodiments, determining module 1510 may perform certain of the determining functions of the apparatus 1500. For example, determining module 1510 may determine that the wireless device has data to transmit in the SL buffer.

According to certain embodiments, initiating module 1520 may perform certain of the initiating functions of the apparatus 1500. For example, initiating module 1520 may initiate a special RACH procedure for transitioning into a connected mode or for requesting an on-demand V2X configuration.

According to certain embodiments, receiving module 1530 may perform certain of the receiving functions of the apparatus 1500. For example, receiving module 1530 may receive, from the network node via the uplink, a grant for transmitting at least the data in the SL buffer.

According to certain embodiments, transmitting module 1540 may perform certain of the transmitting functions of the apparatus 1500. For example, transmitting module 1540 may transmit, based on the grant, at least the data in the SL buffer.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

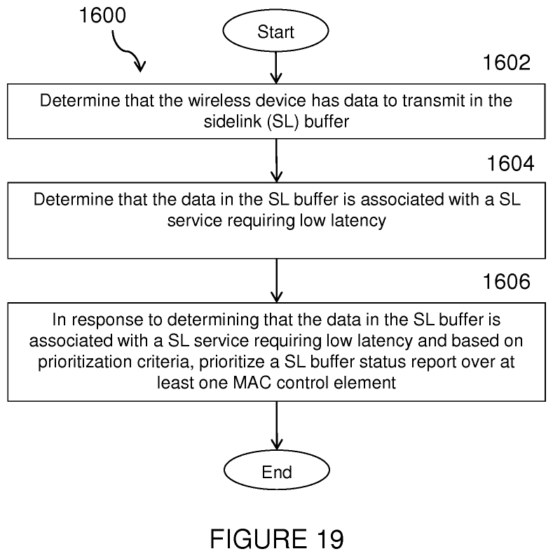

FIG. 19 depicts another method 1600 by a wireless device 110, according to certain embodiments. At step 1602, the wireless device determines that the wireless device has data to transmit in the SL buffer. At step 1604, the wireless device 110 determines that the data in the SL buffer is associated with a SL service requiring low latency. In response to determining that the data in the SL buffer is associated with a SL service requiring low latency and based on prioritization criteria, the wireless device 110 prioritizes a SL buffer status report over at least one MAC control element, at step 1606.

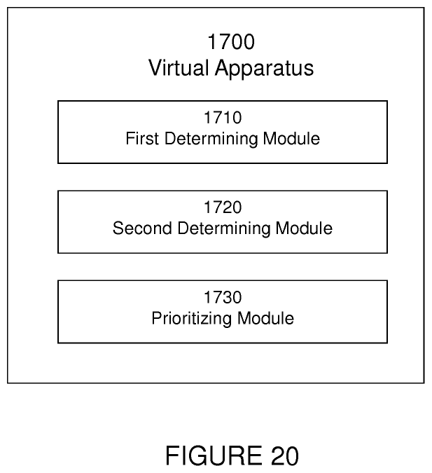

FIG. 20 illustrates a schematic block diagram of a virtual apparatus 1700 in a wireless network (for example, the wireless network shown in FIG. 2). The apparatus may be implemented in a wireless device or network node (e.g., wireless device 110 or network node 160 shown in FIG. 2). Apparatus 1700 is operable to carry out the example method described with reference to FIG. 19 and possibly any other processes or methods disclosed herein. It is also to be understood that the method of FIG. 19 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 1710, second determining module 1720, prioritizing module 1730, and any other suitable units of apparatus 1700 to perform corresponding functions according one or more embodiments of the present disclosure.

According to certain embodiments, first determining module 1710 may perform certain of the determining functions of the apparatus 1700. For example, determining module 1710 may determine that the wireless device has data to transmit in the SL buffer.

According to certain embodiments, second determining module 1720 may perform certain of the determining functions of the apparatus 1700. For example, second determining module 1720 may determine that the data in the SL buffer is associated with a SL service requiring low latency.

According to certain embodiments, prioritizing module 1730 may perform certain of the prioritizing functions of the apparatus 1700. For example, prioritizing module 1730 may, in response to determining that the data in the SL buffer is associated with a SL service requiring low latency and based on prioritization criteria, prioritize a SL buffer status report over at least one MAC control element.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein

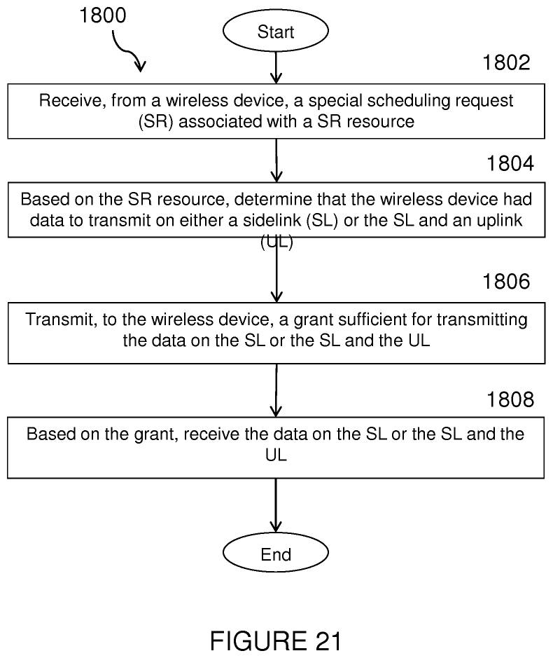

FIG. 21 depicts a method 1800 by a network node 160, according to certain embodiments. At step 1802, the network node 160 receives, from a wireless device 110, a special SR associated with a SR resource. Based on the SR resource, the network node 160 determines that the wireless device 110 had data to transmit on either a SL or the SL and an UL, at step 1804. At step 1806, network node 160 transmits, to the wireless device 110, a grant sufficient for transmitting the data on the SL or the SL and the UL. Based on the grant, the network node 160 receives the data on the SL or the SL and the UL, at step 1808.

In a particular embodiment, the SR resource includes at least one dedicated SL resource. In a further particular embodiment, the SL SR resource includes a single dedicated SL SR resource on a PUCCH or a plurality of dedicated SL SR resources on the PUCCH. In a further particular embodiment, each of the plurality of dedicated SL SR resources corresponds to one or more SL logical channels.

In a particular embodiment, a PUCCH carrying the special SR is scrambled by SL RNTI.

In a particular embodiment, the at least one dedicated SL SR resource comprises one or more bits in a bitmap of a multi-bit SR used for the SL, wherein each of the one or more bits is mapped to an associated one of one or more SL logical channels.

In a particular embodiment, the UE has data to transmit on both the SL and an UL. In a further particular embodiment, the SR resource is an earlier of a SL SR resource and a Uu SR resource. In a further particular embodiment, at least one of the data to be transmitted on the SL and the data to be transmitted on the Uu has a priority greater than a threshold. In a further particular embodiment, the SR resource comprises the Uu SR resource and the data to be transmitted on the SL has a priority that is greater than a priority of the data to be transmitted on the Uu. In a further particular embodiment, the SR resource comprises a Uu SR resource and the Uu SR resource is configured with a priority of the highest priority data to be transmitted on the SL is greater than a threshold.

In a particular embodiment, the method further includes transmitting, to a wireless device, prioritization criteria for prioritizing a SL buffer status report associated with a SL service requiring low latency over at least one MAC control element and, based on the prioritization criteria, receiving the SL buffer status report that is prioritized over the at least one MAC control element.

In a particular embodiment, the buffer status report is received before the MAC control element.

In a particular embodiment, the prioritization criteria is transmitted to the wireless device via dedicated RRC signaling or common RRC signaling.

In a particular embodiment, the prioritization criteria indicates that SL buffer status report is prioritized in response to one of the following: a packet of the data in the SL buffer has a priority higher than a threshold, a highest priority packet of the data in the SL buffer has a priority higher than a threshold, a highest priority packet in the SL buffer has a higher priority than a priority of a highest priority packet of data in a Uu buffer, a highest priority packet in a Uu buffer is lower than a threshold, and a previously transmitted SR was transmitted on a SL SR resource.

In a particular embodiment, the method further includes receiving, from the wireless device, a SL SR indicating that the data in the SL buffer is prioritized based on the prioritization criteria.

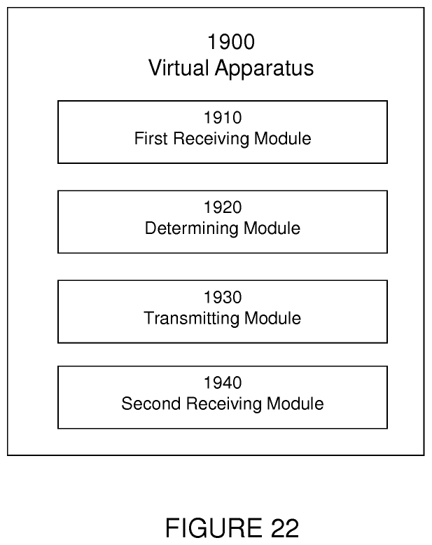

FIG. 22 illustrates a schematic block diagram of a virtual apparatus 1900 in a wireless network (for example, the wireless network shown in FIG. 2). The apparatus may be implemented in a wireless device or network node (e.g., wireless device 110 or network node 160 shown in FIG. 2). Apparatus 1900 is operable to carry out the example method described with reference to FIG. 21 and possibly any other processes or methods disclosed herein. It is also to be understood that the method of FIG. 21 is not necessarily carried out solely by apparatus 1900. At least some operations of the method can be performed by one or more other entities. Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiving module 1910, determining module 1920, transmitting module 1930, second receiving module 1940, and any other suitable units of apparatus 1900 to perform corresponding functions according one or more embodiments of the present disclosure.

According to certain embodiments, first receiving module 1910 may perform certain of the receiving functions of the apparatus 1900. For example, first receiving module 1910 may receive, from a wireless device, a special scheduling request (SR) associated with a SR resource.

According to certain embodiments, determining module 1920 may perform certain of the determining functions of the apparatus 1900. For example, determining module 1920 may determine, based on the SR resource, that the UE had data to transmit on either a sidelink (SL) or the SL and an uplink (UL.

According to certain embodiments, transmitting module 1930 may perform certain of the transmitting functions of the apparatus 1900. For example, transmitting module 1930 may transmit, to the wireless device, a grant sufficient for transmitting the data on the SL or the SL and the UL.

According to certain embodiments, second receiving module 1940 may perform certain of the receiving functions of the apparatus 1900. For example, second receiving module 1940 may, based on the grant, receive the network node receives the data on the SL or the SL and the UL.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

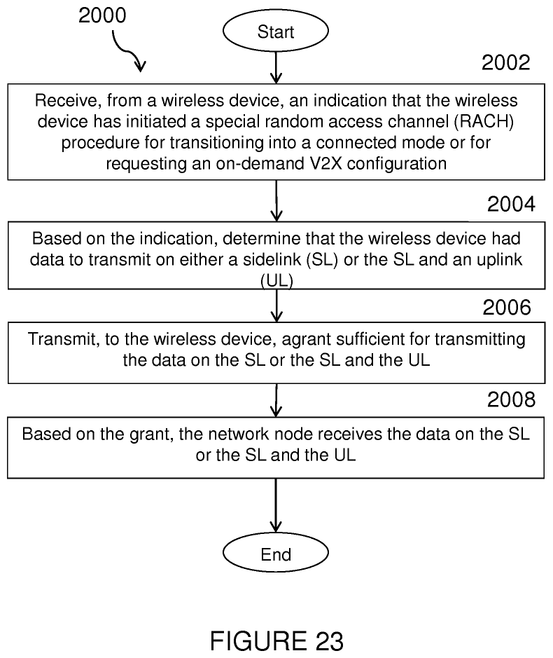

FIG. 23 depicts a method 2000 by a network node 160, according to certain embodiments. At step 2002, the network node 160 receives, from a wireless device 110, an indication that the wireless device 110 has initiated a special RACH procedure for transitioning into a connected mode or for requesting an on-demand V2X configuration. Based on the indication, the network node 160 determines that the wireless device 110 had data to transmit on either a SL or the SL and an UL, at step 2004. At step 2006, the network node 160 transmits, to the wireless device 110, a grant sufficient for transmitting the data on the SL or the SL and the UL. Based on the grant, the network node 160 receives the data on the SL or the SL and the UL, at step 1808.

In a particular embodiment, requesting the on-demand V2X configuration comprises requesting at least one SL resource and receiving the UL grant comprises receiving the SL resource.

In a particular embodiment, the request for the on-demand V2X configuration comprises a request for system information block (SIB) signaling comprising a SL V2X related configuration.

In a particular embodiment, the SL V2X related configuration comprises at least one of: a SL time resource, a SL frequency resource, and one or more transmission parameters.

In a particular embodiment, the special RACH procedure is used for PRACH SL scheduling request (SR) when the wireless device has reached a maximum amount of SL SR attempts.

In a particular embodiment, the special RACH procedure comprises a special RACH preamble format and/or resource.

In a particular embodiment, the indication is received in a message 3. In a further particular embodiment, the message 3 includes a field indicating to a network node that: the wireless device data has data to transmit in the SL buffer, or the wireless device has data to transmit in the SL buffer and data to transmit in an Uu buffer. In a further particular embodiment, the data to transmit in the SL buffer has a priority greater than a threshold. In a further particular embodiment, the data to transmit in the SL buffer has a priority that is greater than a priority of the data to transmit in the Uu buffer.

In a particular embodiment, the message 3 indicates a plurality of carriers mapped to data in the SL buffer that has a priority greater than a threshold. In a further particular embodiment, the message 3 indicates that a plurality of carriers mapped to data in the SL buffer that has a higher priority than data in a Uu buffer.

In a particular embodiment, selecting the SR resource comprises selecting an earlier of a SL SR resource and a Uu SR resource.

In another particular embodiment, the message 3 indicates a priority of the data in the SL buffer. In still another embodiment, the message 3 comprises a V2X service identifier of data in the SL buffer having a priority higher than a threshold or higher than a priority of data in a Uu buffer.

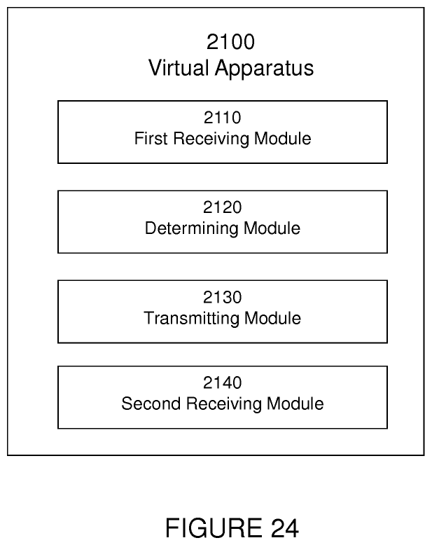

FIG. 24 illustrates a schematic block diagram of a virtual apparatus 2100 in a wireless network (for example, the wireless network shown in FIG. 2). The apparatus may be implemented in a wireless device or network node (e.g., wireless device 110 or network node 160 shown in FIG. 2). Apparatus 2100 is operable to carry out the example method described with reference to FIG. 23 and possibly any other processes or methods disclosed herein. It is also to be understood that the method of FIG. 23 is not necessarily carried out solely by apparatus 2100. At least some operations of the method can be performed by one or more other entities.

Virtual Apparatus 2100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiving module 2110, determining module 2120, transmitting module 2130, second receiving module 2140, and any other suitable units of apparatus 2100 to perform corresponding functions according one or more embodiments of the present disclosure.

According to certain embodiments, first receiving module 2110 may perform certain of the receiving functions of the apparatus 2100. For example, first receiving module 2110 may receive, from a wireless device, an indication that the wireless device has initiated a special RACH procedure to transition into a connected mode or to request an on-demand V2X configuration.

According to certain embodiments, determining module 2120 may perform certain of the determining functions of the apparatus 2100. For example, determining module 2120 may determine, based on the indication, that the UE had data to transmit on either a SL or the SL and an UL.

According to certain embodiments, transmitting module 2130 may perform certain of the transmitting functions of the apparatus 2100. For example, transmitting module 2130 may transmit, to the wireless device, a grant sufficient for transmitting the data on the SL or the SL and the UL.

According to certain embodiments, second receiving module 2140 may perform certain of the receiving functions of the apparatus 2100. For example, second receiving module 2140 may receive, based on the grant, the data on the SL or the SL and the UL.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

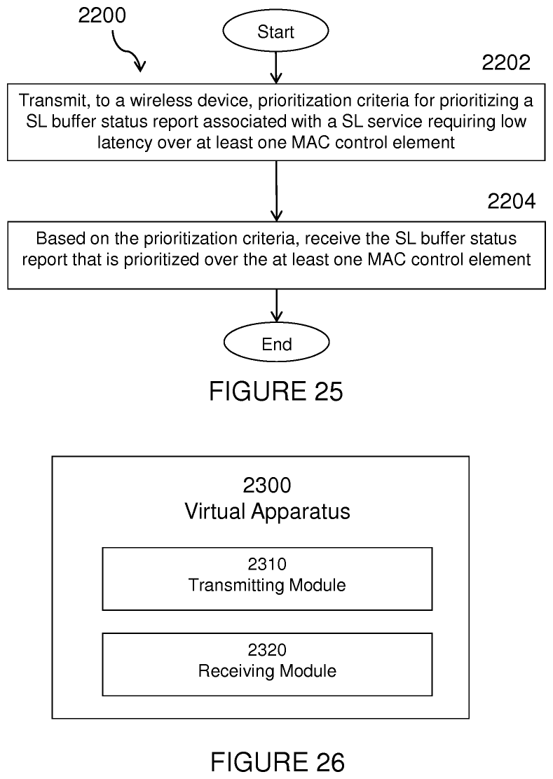

FIG. 25 depicts a method 2200 by a network node, according to certain embodiments. At step 2202, the network node transmits, to a wireless device, prioritization criteria for prioritizing a SL buffer status report associated with a SL service requiring low latency over at least one MAC control element. Based on the prioritization criteria, the network node receives the SL buffer status report that is prioritized over the at least one MAC control element, at step 2204.

FIG. 26 illustrates a schematic block diagram of a virtual apparatus 2300 in a wireless network (for example, the wireless network shown in FIG. 2). The apparatus may be implemented in a wireless device or network node (e.g., wireless device 110 or network node 160 shown in FIG. 2). Apparatus 2300 is operable to carry out the example method described with reference to FIG. 25 and possibly any other processes or methods disclosed herein. It is also to be understood that the method of FIG. 25 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 2310, receiving module 2320, and any other suitable units of apparatus 2300 to perform corresponding functions according one or more embodiments of the present disclosure.

According to certain embodiments, transmitting module 2310 may perform certain of the transmitting functions of the apparatus 2300. For example, transmitting module 2310 may transmit, to a wireless device, prioritization criteria for prioritizing a SL buffer status report associated with a SL service requiring low latency over at least one MAC control element.

According to certain embodiments, receiving module 2320 may perform certain of the receiving functions of the apparatus 2300. For example, receiving module 320 may receive, based on the prioritization criteria, the SL buffer status report that is prioritized over the at least one MAC control element.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EXAMPLE EMBODIMENTS

Group A1 Embodiments

Embodiments 1. A method performed by a wireless device for improving network efficiency, the method comprising:

determining that the wireless device has data to transmit in the sidelink (SL) buffer;

selecting a scheduling request (SR) resource to transmit, to a network node, a special scheduling request to indicate that a SL resource allocation (SL RA) is needed;

transmitting, using the SR resource, the special scheduling request to the network node to indicate that the SL RA is needed;

receiving, from the network node, an uplink grant for transmitting at least the data in the SL buffer;

based on the uplink grant, transmitting at least the data in the SL buffer.

Embodiment 2. The method of Embodiment 1, wherein the SR resource comprises at least one dedicated SL resource.

Embodiment 3. The method of Embodiment 2, wherein the at least one dedicated SL SR resource comprises a single dedicated SL SR resource on a physical uplink control channel (PUCCH).

Embodiment 4. The method of Embodiment 2, wherein the at least one dedicated SL SR resource comprises a plurality of dedicated SL SR resources on a physical uplink control channel (PUCCH).

Embodiment 5. The method of Embodiment 4, wherein each of the plurality of dedicated SL SR resources corresponds to one or more SL logical channels.

Embodiment 6. The method of Embodiment 2, wherein using the at least one dedicated SL SR resource to transmit the special SR comprises scrambling a physical uplink control channel carrying the special SR by SL radio network temporary identifier (RNTI).

Embodiment 7. The method of Embodiment 2, wherein the at least one dedicated SL SR resource comprises one or more bits in a bitmap of a multi-bit SR used for the SL, wherein each of the one or more bits is mapped to an associated one of one or more SL logical channels.

Embodiment 8. The method of Embodiment 1, further comprising determining that the wireless device has data in a Uu buffer to transmit, and wherein the special scheduling request indicates that the wireless device also has data in the Uu buffer to transmit.

Embodiment 9. The method of Embodiment 8, wherein selecting the SR resource comprises selecting an earlier of a SL SR resource and a Uu SR resource.

Embodiment 10. The method of Embodiment 9, wherein the earlier of the SL SR resource and the Uu SR resource are selected in response to determining that the data in the SL buffer or the Uu buffer has a priority greater than a threshold.

Embodiment 11. The method of Embodiment 9, wherein the Uu SR resource is selected in response to determining that the data in the SL buffer has a priority greater than a threshold.

Embodiment 12. The method of Embodiment 9, wherein the Uu SR resource is selected in response to determining that the data in the SL buffer has a priority that is greater than a priority of the data in the Uu buffer.

Embodiment 13. The method of Embodiment 1, wherein the SR resource comprises a Uu SR resource and a priority of the highest priority data in the SL buffer is greater than a threshold.

Group B1 Embodiments

Embodiment 14. A method performed by a base station for improving network efficiency, the method comprising:

receiving, from a wireless device, a special scheduling request (SR) associated with a SR resource;

based on the SR resource, determining that the UE had data to transmit on either a sidelink (SL) or the SL and an uplink (UL);

transmitting, to the wireless device, an uplink grant sufficient for transmitting the data on the SL or the SL and the UL;

based on the uplink grant, receiving the data on the SL or the SL and the UL.

Embodiment 15. The method of Embodiment 14, wherein the SR resource comprises at least one dedicated SL resource.

Embodiment 16. The method of Embodiment 15, wherein the at least one dedicated SL SR resource comprises a single dedicated SL SR resource on a physical uplink control channel (PUCCH).

Embodiment 17. The method of Embodiment 15, the at least one dedicated SL SR resource comprises a plurality of dedicated SL SR resources on a physical uplink control channel (PUCCH).

Embodiment 18. The method of Embodiment 17, wherein each of the plurality of dedicated SL SR resources corresponds to one or more SL logical channels.

Embodiment 19. The method of Embodiment 15, wherein a physical uplink control channel carrying the special SR is scrambled by SL radio network temporary identifier (RNTI).

Embodiment 20. The method of Embodiment 15, wherein the at least one dedicated SL SR resource comprises one or more bits in a bitmap of a multi-bit SR used for the SL, wherein each of the one or more bits is mapped to an associated one of one or more SL logical channels.

Embodiment 21. The method of Embodiment 14, wherein the UE has data to transmit on both the SL and an UL.

Embodiment 22. The method of Embodiment 21, wherein the SR resource is an earlier of a SL SR resource and a Uu SR resource.

Embodiment 23. The method of Embodiment 22, wherein at least one of the data to be transmitted on the SL and the data to be transmitted on the Uu has a priority greater than a threshold.

Embodiment 24. The method of Embodiment 22, wherein the SR resource comprises the Uu SR resource and the data to be transmitted on the SL has a priority greater than a threshold.

Embodiment 25. The method of Embodiment 22, wherein the SR resource comprises the Uu SR resource and the data to be transmitted on the SL has a priority that is greater than a priority of the data to be transmitted on the Uu.

Embodiment 26. The method of Embodiment 14, wherein the SR resource comprises a Uu SR resource and a priority of the highest priority data to be transmitted on the SL is greater than a threshold.

Group A2 Embodiments

Embodiment 27. A method performed by a wireless device for improving network efficiency, the method comprising:

determining that the wireless device has data to transmit in the sidelink (SL) buffer;

initiating a special random access channel (RACH) procedure to transition into a connected mode or to request an on-demand V2X configuration;

receiving, from the network node, an uplink grant for transmitting at least the data in the SL buffer;

based on the uplink grant, transmitting at least the data in the SL buffer.

Embodiment 28. The method of Embodiment 27, wherein requesting an on-demand V2X configuration comprises: transmitting, to a network node, a request for system information block (SIB) signaling comprising a SL V2X related configuration

Embodiment 29. The method of Embodiment 28, wherein the SL V2X related configuration comprises at least one of SL time resource or a SL frequency resource.

Embodiment 30. The method of Embodiment 28, wherein the SL V2X related configuration comprises transmission parameters.

Embodiment 31. The method of any one of Embodiments 27 to 30, wherein the special RACH procedure is used for PRACH SL scheduling request (SR) when the wireless device has reached a maximum amount of SL SR attempts.

Embodiment 32. The method of any one of Embodiments 27 to 31, wherein the special RACH procedure comprises a special RACH preamble format and/or resource.

Embodiment 33. The method of any one of Embodiments 27 to 32, wherein initiating the special RACH procedure comprises transmitting an indication in a message 3.

Embodiment 34. The method of Embodiment 33, wherein the message 3 comprises a field indicating to a network node that the wireless device data has data to transmit in the SL buffer.

Embodiment 35. The method of Embodiment 33, wherein the message 3 comprises a field indicating to the network node that the wireless device has data to transmit in the SL buffer and data to transmit in an Uu buffer.

Embodiment 36. The method of Embodiment 35, wherein the data to transmit in the SL buffer has a priority greater than a threshold.

Embodiment 37. The method of Embodiment 35, wherein the data to transmit in the SL buffer has a priority that is greater than a priority of the data to transmit in the Uu buffer.

Embodiment 38. The method of Embodiment 33, wherein the message 3 indicates a plurality of carriers mapped to data in the SL buffer that has a priority greater than a threshold.

Embodiment 39. The method of Embodiment 33, wherein the message 3 indicates a plurality of carriers mapped to data in the SL buffer that has a higher priority than data in a Uu buffer. selecting the SR resource comprises selecting an earlier of a SL SR resource and a Uu SR resource.

Embodiment 40. The method of Embodiment 33, wherein the message 3 indicates a priority of the data in the SL buffer.

Embodiment 41. The method of Embodiment 33, wherein the message 3 comprises a V2X service identifier of data in the SL buffer having a priority higher than a threshold or higher than a priority of data in a Uu buffer.

Group B2 Embodiments

Embodiment 42. A method performed by a base station for improving network efficiency, the method comprising:

receiving, from a wireless device, an indication that the wireless device has initiated a special random access channel (RACH) procedure to transition into a connected mode or to request an on-demand V2X configuration;

based on the indication, determining that the UE had data to transmit on either a sidelink (SL) or the SL and an uplink (UL);

transmitting, to the wireless device, an uplink grant sufficient for transmitting the data on the SL or the SL and the UL;

based on the uplink grant, receiving the data on the SL or the SL and the UL

Embodiment 43. The method of Embodiment 42, wherein the request for the on- demand V2X configuration comprises: a request for system information block (SIB) signaling comprising a SL V2X related configuration.

Embodiment 44. The method of Embodiment 43, wherein the SL V2X related configuration comprises at least one of SL time resource or a SL frequency resource.

Embodiment 45. The method of Embodiment 43, wherein the SL V2X related configuration comprises transmission parameters.

Embodiment 46. The method of any one of Embodiments 42 to 46, wherein the special RACH procedure is used for PRACH SL scheduling request (SR) when the wireless device has reached a maximum amount of SL SR attempts.

Embodiment 47. The method of any one of Embodiments 42 to 47, wherein the special RACH procedure comprises a special RACH preamble format and/or resource.

Embodiment 48. The method of any one of Embodiments 42 to 47, wherein the indication is received in a message 3.

Embodiment 49. The method of Embodiment 48, wherein the message 3 comprises a field indicating to a network node that the wireless device data has data to transmit in the SL buffer.

Embodiment 50. The method of Embodiment 48, wherein the message 3 comprises a field indicating to the network node that the wireless device has data to transmit in the SL buffer and data to transmit in an Uu buffer.

Embodiment 51. The method of Embodiment 50, wherein the data to transmit in the SL buffer has a priority greater than a threshold.

Embodiment 52. The method of Embodiment 50, wherein the data to transmit in the SL buffer has a priority that is greater than a priority of the data to transmit in the Uu buffer.

Embodiment 53. The method of Embodiment 48, wherein the message 3 indicates a plurality of carriers mapped to data in the SL buffer that has a priority greater than a threshold.

Embodiment 54. The method of Embodiment 48, wherein the message 3 indicates a plurality of carriers mapped to data in the SL buffer that has a higher priority than data in a Uu buffer. selecting the SR resource comprises selecting an earlier of a SL SR resource and a Uu SR resource.

Embodiment 55. The method of Embodiment 48, wherein the message 3 indicates a priority of the data in the SL buffer.

Embodiment 56. The method of Embodiment 48, wherein the message 3 comprises a V2X service identifier of data in the SL buffer having a priority higher than a threshold or higher than a priority of data in a Uu buffer.

Group A3 Embodiments

Embodiment 57. A method performed by a wireless device for improving network efficiency, the method comprising:

determining that the wireless device has data to transmit in the sidelink (SL) buffer;

determining that the data in the SL buffer is associated with a SL service requiring low latency; and

in response to determining that the data in the SL buffer is associated with a SL service requiring low latency and based on prioritization criteria, prioritizing a SL buffer status report over at least one MAC control element.

Embodiment 58. The method of Embodiment 57, wherein prioritizing the SL buffer status report comprises transmitting the buffer status report to a network node before the MAC control element.

Embodiment 59. The method of any one of Embodiments 57 to 58, wherein the prioritization criteria is received via dedicated RRC signaling.

Embodiment 60. The method of any one of Embodiments 57 to 58, wherein the prioritization criteria is received via common RRC signaling.

Embodiment 61. The method of any one of Embodiments 57 to 60, wherein the prioritization criteria indicates that SL buffer status report is prioritized if a packet of the data in the SL buffer has a priority higher than a threshold.

Embodiment 62. The method of any one of Embodiments 57 to 60, wherein the prioritization criteria indicates that SL buffer status report is prioritized if a highest priority packet of the data in the SL buffer has a priority higher than a threshold.

Embodiment 63. The method of any one of Embodiments 57 to 60, wherein the prioritization criteria indicates that SL buffer status report is prioritized if a highest priority packet in the SL buffer has a higher priority than a priority of a highest priority packet of data in a Uu buffer.

Embodiment 64. The method of any one of Embodiments 57 to 60, wherein the prioritization criteria indicates that SL buffer status report is prioritized if a highest priority packet in a Uu buffer is lower than a threshold.

Embodiment 65. The method of any one of Embodiments 57 to 60, wherein the prioritization criteria indicates that SL buffer status report is prioritized if a previously transmitted SR was transmitted on a SL SR resource.

Embodiment 66. The method of any one of Embodiments 62 to 65, further comprising transmitting a SL SR to a network node, the SL SR indicating that the data in the SL buffer is prioritized based on the prioritization criteria.

Group B3 Embodiments

Embodiment 67. A method performed by a base station for improving network efficiency, the method comprising:

transmitting, to a wireless device, prioritization criteria for prioritizing a SL buffer status report associated with a SL service requiring low latency over at least one MAC control element; and

based on the prioritization criteria, receiving the SL buffer status report that is prioritized over the at least one MAC control element.

Embodiment 68. The method of Embodiment 67, wherein the buffer status report is received before the MAC control element.

Embodiment 69. The method of any one of Embodiments 67 to 68, wherein the prioritization criteria is transmitted to the wireless device via dedicated RRC signaling.

Embodiment 70. The method of any one of Embodiments 67 to 78, wherein the prioritization criteria is transmitted to the wireless device via common RRC signaling. Embodiment 71. The method of any one of Embodiments 67 to 70, wherein the prioritization criteria indicates that SL buffer status report is prioritized if a packet of the data in the SL buffer has a priority higher than a threshold.

Embodiment 72. The method of any one of Embodiments 67 to 70, wherein the prioritization criteria indicates that SL buffer status report is prioritized if a highest priority packet of the data in the SL buffer has a priority higher than a threshold.

Embodiment 73. The method of any one of Embodiments 67 to 70, wherein the prioritization criteria indicates that SL buffer status report is prioritized if a highest priority packet in the SL buffer has a higher priority than a priority of a highest priority packet of data in a Uu buffer.

Embodiment 74. The method of any one of Embodiments 67 to 70, wherein the prioritization criteria indicates that SL buffer status report is prioritized if a highest priority packet in a Uu buffer is lower than a threshold.

Embodiment 75. The method of any one of Embodiments 67 to 70, wherein the prioritization criteria indicates that SL buffer status report is prioritized if a previously transmitted SR was transmitted on a SL SR resource.

Embodiment 76. The method of any one of Embodiments 67 to 75, further comprising receiving, from the wireless device, a SL SR indicating that the data in the SL buffer is prioritized based on the prioritization criteria.

Group C Embodiments

Embodiment 77. A wireless device for improving network efficiency, the wireless device comprising:

processing circuitry configured to perform any of the steps of any of the Group A1, A2, and A3 embodiments; and

power supply circuitry configured to supply power to the wireless device.

Embodiment 78. A base station for improving network efficiency, the base station comprising:

processing circuitry configured to perform any of the steps of any of the Group B1, B2, and B3 embodiments;

power supply circuitry configured to supply power to the wireless device.

Embodiment 79. A user equipment (UE) for improving network efficiency, the UE comprising:

an antenna configured to send and receive wireless signals;

radio front-end circuitry connected to the antenna and to processing circuitry, and configured to condition signals communicated between the antenna and the processing circuitry;

the processing circuitry being configured to perform any of the steps of any of the Group A1, A2, and A3 embodiments;

an input interface connected to the processing circuitry and configured to allow input of information into the UE to be processed by the processing circuitry;

an output interface connected to the processing circuitry and configured to output information from the UE that has been processed by the processing circuitry; and

a battery connected to the processing circuitry and configured to supply power to the UE.

Embodiment 80. A communication system including a host computer comprising:

processing circuitry configured to provide user data; and

a communication interface configured to forward the user data to a cellular network for transmission to a user equipment (UE),

wherein the cellular network comprises a base station having a radio interface and processing circuitry, the base station's processing circuitry configured to perform any of the steps of any of the Group B1, B2, and B3 embodiments.

Embodiment 81. The communication system of the pervious embodiment further including the base station.

Embodiment 82. The communication system of the previous 2 embodiments, further including the UE, wherein the UE is configured to communicate with the base station.

Embodiment 83. The communication system of the previous 3 embodiments, wherein:

the processing circuitry of the host computer is configured to execute a host application, thereby providing the user data; and

the UE comprises processing circuitry configured to execute a client application associated with the host application.

Embodiment 84. A method implemented in a communication system including a host computer, a base station and a user equipment (UE), the method comprising:

at the host computer, providing user data; and

at the host computer, initiating a transmission carrying the user data to the UE via a cellular network comprising the base station, wherein the base station performs any of the steps of any of the Group B1, B2, and B3 embodiments.

Embodiment 85. The method of the previous embodiment, further comprising, at the base station, transmitting the user data.

Embodiment 86. The method of the previous 2 embodiments, wherein the user data is provided at the host computer by executing a host application, the method further comprising, at the UE, executing a client application associated with the host application.

Embodiment 87. A user equipment (UE) configured to communicate with a base station, the UE comprising a radio interface and processing circuitry configured to performs the of the previous 3 embodiments.

Embodiment 88. A communication system including a host computer comprising:

processing circuitry configured to provide user data; and

a communication interface configured to forward user data to a cellular network for transmission to a user equipment (UE),

wherein the UE comprises a radio interface and processing circuitry, the UE's components configured to perform any of the steps of any of the Group A1, A2, and A3 embodiments.

Embodiment 89. The communication system of the previous embodiment, wherein the cellular network further includes a base station configured to communicate with the UE.

Embodiment 90. The communication system of the previous 2 embodiments, wherein:

the processing circuitry of the host computer is configured to execute a host application, thereby providing the user data; and

the UE's processing circuitry is configured to execute a client application associated with the host application.

Embodiment 91. A method implemented in a communication system including a host computer, a base station and a user equipment (UE), the method comprising:

at the host computer, providing user data; and

at the host computer, initiating a transmission carrying the user data to the UE via a cellular network comprising the base station, wherein the UE performs any of the steps of any of the Group A1, A2, and A3 embodiments.

Embodiment 92. The method of the previous embodiment, further comprising at the UE, receiving the user data from the base station.

Embodiment 93. A communication system including a host computer comprising:

communication interface configured to receive user data originating from a transmission from a user equipment (UE) to a base station,

wherein the UE comprises a radio interface and processing circuitry, the UE's processing circuitry configured to perform any of the steps of any of the Group A1, A2, and A3 embodiments.

Embodiment 94. The communication system of the previous embodiment, further including the UE.

Embodiment 95. The communication system of the previous 2 embodiments, further including the base station, wherein the base station comprises a radio interface configured to communicate with the UE and a communication interface configured to forward to the host computer the user data carried by a transmission from the UE to the base station.

Embodiment 96. The communication system of the previous 3 embodiments, wherein:

the processing circuitry of the host computer is configured to execute a host application; and

the UE's processing circuitry is configured to execute a client application associated with the host application, thereby providing the user data.

Embodiment 97. The communication system of the previous 4 embodiments, wherein:

the processing circuitry of the host computer is configured to execute a host application, thereby providing request data; and

the UE's processing circuitry is configured to execute a client application associated with the host application, thereby providing the user data in response to the request data.

Embodiment 98. A method implemented in a communication system including a host computer, a base station and a user equipment (UE), the method comprising: at the host computer, receiving user data transmitted to the base station from the UE, wherein the UE performs any of the steps of any of the Group A1, A2, and A3 embodiments.

Embodiment 99. The method of the previous embodiment, further comprising, at the UE, providing the user data to the base station.

Embodiment 100. The method of the previous 2 embodiments, further comprising:

at the UE, executing a client application, thereby providing the user data to be transmitted; and

at the host computer, executing a host application associated with the client application.

Embodiment 101. The method of the previous 3 embodiments, further comprising:

at the UE, executing a client application; and

at the UE, receiving input data to the client application, the input data being provided at the host computer by executing a host application associated with the client application,

wherein the user data to be transmitted is provided by the client application in response to the input data.

Embodiment 102. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B1, B2, and B3 embodiments.

Embodiment 103. The communication system of the previous embodiment further including the base station.

Embodiment 104. The communication system of the previous 2 embodiments, further including the UE, wherein the UE is configured to communicate with the base station.

Embodiment 105. The communication system of the previous 3 embodiments, wherein:

the processing circuitry of the host computer is configured to execute a host application;

the UE is configured to execute a client application associated with the host application, thereby providing the user data to be received by the host computer.

Embodiment 106. A method implemented in a communication system including a host computer, a base station and a user equipment (UE), the method comprising: at the host computer, receiving, from the base station, user data originating from a transmission which the base station has received from the UE, wherein the UE performs any of the steps of any of the Group A1, A2, and A3 embodiments.

Embodiment 107. The method of the previous embodiment, further comprising at the base station, receiving the user data from the UE.

Embodiment 108. The method of the previous 2 embodiments, further comprising at the base station, initiating a transmission of the received user data to the host computer.

1. A method performed by a wireless device, the method comprising:
determining that the wireless device has data to transmit in at least a sidelink, SL, buffer;
transmitting, using a scheduling request, SR, resource, a special scheduling request to a network node to indicate that a SL resource allocation, SL RA, is needed;
receiving, from the network node, a grant for transmitting at least the data in the SL buffer; and
based on the grant, transmitting at least the data in the SL buffer.

2. The method of claim 1, wherein the SR resource comprises at least one dedicated SL resource, the at least one dedicated SL SR resource comprising a single dedicated SL SR resource on a physical uplink control channel, PUCCH, or a plurality of dedicated SL SR resources corresponding to one or more SL logical channels on the PUCCH.

3. The method of claim 2, wherein the at least one dedicated SL SR resource comprises one or more bits in a bitmap of a multi-bit SR used for the SL, wherein each of the one or more bits is mapped to an associated one of one or more SL logical channels.

4. The method of claim 1, further comprising determining that the wireless device has data in a Uu buffer to transmit, and wherein the special scheduling request indicates that the wireless device also has data in the Uu buffer to transmit.

5. The method of claim 4, further comprising transmitting, based on the grant, the data in the Uu buffer.

6.-10. (canceled)

11. A method performed by a base station, the method comprising:
receiving, from a wireless device, a special scheduling request, SR, associated with a SR resource;
based on the SR resource, determining that the wireless device has data to transmit on either a sidelink, SL, or the SL and an uplink, UL;
transmitting, to the wireless device (110), a grant sufficient for transmitting the data on the SL or the SL and the UL.

12.-32. (cancaled)

33. A wireless device comprising:
processing circuitry configured to:
determine that the wireless device has data to transmit in at least a sidelink, SL, buffer;
transmit, using a scheduling request, SR, resource, a special scheduling request to a network node to indicate that a SL resource allocation, SL RA, is needed;
receive, from the network node, a grant for transmitting at least the data in the SL buffer; and
based on the grant, transmit at least the data in the SL buffer.

34. The wireless device of claim 33, wherein the SR resource comprises at least one dedicated SL resource, the at least one dedicated SL SR resource comprising a single dedicated SL SR resource on a physical uplink control channel, PUCCH, or a plurality of dedicated SL SR resources corresponding to one or more SL logical channels on the PUCCH.

35. The wireless device of claim 34, wherein the at least one dedicated SL SR resource comprises one or more bits in a bitmap of a multi-bit SR used for the SL, wherein each of the one or more bits is mapped to an associated one of one or more SL logical channels.

36. The wireless device of claim 33, wherein the processing circuitry is configured to determine that the wireless device has data in a Uu buffer to transmit, and wherein the special scheduling request indicates that the wireless device also has data in the Uu buffer to transmit.

37. The wireless device of claim 36, wherein the processing circuitry is configured to transmit, based on the grant, the data in the Uu buffer.

38. The wireless device of claim 37, wherein the data that is transmitted includes a SL buffer status report, SL BSR, and a uplink buffer status report, Uu BSR.

39. The wireless device of claim 33, wherein the processing circuitry is configured to:
determine that the data in the SL buffer is associated with a SL service requiring low latency; and
in response to determining that the data in the SL buffer is associated with a SL service requiring low latency and based on prioritization criteria, prioritize a SL buffer status report over at least one MAC control element.

40. The wireless device of claim 39, wherein prioritizing the SL buffer status report comprises transmitting the buffer status report to a network node before the at least one MAC control element.

41. The wireless device of claim 39, wherein the prioritization criteria indicates that SL buffer status report is prioritized in response to at least one of the following:
a packet of the data in the SL buffer has a priority higher than a threshold,
a highest priority packet of the data in the SL buffer has a priority higher than a threshold,
a highest priority packet in the SL buffer has a higher priority than a priority of a highest priority packet of data in a Uu buffer, and
a highest priority packet in a Uu buffer is lower than a threshold.

42. The wireless device of claim 33, wherein the processing circuitry is configured to transmit a SL SR to a network node, the SL SR indicating that the data in the SL buffer is prioritized based on the prioritization criteria.

43. A base station comprising:
processing circuitry configured to:
receive, from a wireless device, a special scheduling request (SR) associated with a SR resource;
based on the SR resource, determine that the wireless device has data to transmit on either a sidelink, SL, or the SL and an uplink, UL;
transmit, to the wireless device, a grant sufficient for transmitting the data on the SL or the SL and the UL.

44. The base station of claim 43, wherein the SR resource comprises at least one dedicated SL resource, the at least one dedicated SL SR resource comprising a single dedicated SL SR resource on a physical uplink control channel, PUCCH, or a plurality of dedicated SL SR resources on the PUCCH.

45. The base station of claim 44, wherein each of the plurality of dedicated SL SR resources corresponds to one or more SL logical channels.

46. The base station of claim 44, wherein the at least one dedicated SL SR resource comprises one or more bits in a bitmap of a multi-bit SR used for the SL, wherein each of the one or more bits is mapped to an associated one of one or more SL logical channels.

47. The base station of claim 43, wherein the processing circuitry is configured to determine, based on the SR resource, that the UE has data to transmit on the UL and the method further comprises receiving the data on the UL.

48. The base station of claim 47, wherein the data received on the UL comprises an uplink buffer status report, Uu BSR.

49. The base station of claim 43, wherein the processing circuitry is configured to:
transmit, to a wireless device (110), prioritization criteria for prioritizing a SL buffer status report associated with a SL service requiring low latency over at least one MAC control element; and
based on the prioritization criteria, receive the SL buffer status report that is prioritized over the at least one MAC control element.

50. The base station of claim 49, wherein the buffer status report is received before the MAC control element.

51. The base station of claim 49, wherein the prioritization criteria indicates that SL buffer status report is prioritized in response to one of the following:
a packet of the data in the SL buffer has a priority higher than a threshold,
a highest priority packet of the data in the SL buffer has a priority higher than a threshold,
a highest priority packet in the SL buffer has a higher priority than a priority of a highest priority packet of data in a Uu buffer,
a highest priority packet in a Uu buffer is lower than a threshold, and
a previously transmitted SR was transmitted on a SL SR resource.

52. The base station of claim 49, further comprising receiving, from the wireless device, a SL SR indicating that the data in the SL buffer is prioritized based on the prioritization criteria.

53.-64. (canceled)
